(19) United States
(12) Patent Application Publication
(10) Pub. No.: US 2025/0004842 A1
(43) Pub. Date: Jan. 2, 2025

(54) SCALING MANAGEMENT DEVICE, SCALING MANAGEMENT METHOD, AND PROGRAM

(71) Applicant: Nippon Telegraph and Telephone Corporation, Tokyo (JP)

(72) Inventors: Eriko IWASA, Musashino-shi, Tokyo (JP); Masashi KANEKO, Musashino-shi, Tokyo (JP)

(21) Appl. No.: 18/709,060

(22) PCT Filed: Nov. 15, 2021
(86) PCT No.: PCT/JP2021/041923

§ 371 Date: May 10, 2024

(51) Int. Cl. G06F 9/50

(52) U.S. Cl. CPC G06F 9/5027

(57) ABSTRACT

A scaling management device includes an electric power efficiency characteristic calculation unit that calculates electric power efficiency characteristics of hardware and determines a usage rate at which a value of electric power efficiency is highest, a performance ratio calculation unit that measures performance of hardware, identifies hardware having a lowest performance value, and calculates a performance ratio between the identified hardware and other hardware, a virtual resource number calculation unit that calculates a score obtained by multiplying the performance ratio by the usage rate at which the value of electric power efficiency is highest and calculates the number of virtual resources in accordance with the score, a requested resource calculation unit that calculates requested resources of virtual resources, and, a config file creation unit that creates a scaling config file and a resource config file.

### TECHNICAL FIELD

The present invention relates to a scaling management device, a scaling management method, and a program for controlling scaling in a virtualization platform.

### BACKGROUND ART

In recent years, a virtualization platform has been constructed and server farms such as data centers have been increasingly operating. A virtualization platform is a virtual environment that abstracts and hides physical resources such as servers or networks using virtualization technology and is prepared as a common platform for a plurality of applications or services, as well as a system that manages those virtual environments.

Known open source virtualization platforms include OpenStack which is software for constructing cloud environments, and Kubernetes which is software for operating and managing containerized workloads or services. OpenStack is mainly used to manage and operate physical machines or virtual machines (VMs). Kubernetes is mainly used to manage and operate containers (see NPL 1).

In a virtualization platform constructed in such a data center or the like, there is concern about an increase in power consumption due to IT instruments such as servers, and server farms such as data centers, attention is being focused on electric power efficiency rather than the maximum performance of instruments.

Electric power efficiency is defined as “electric power efficiency=average load/average electric power” (processing amount per watt). In addition, the transition of electric power efficiency at each usage rate (0 to 100%) when electric power efficiency at a usage rate of 100; is set to 1.0 is evaluated as “electric power efficiency characteristics.” It is known that this electric power efficiency tends to vary depending on the architecture of a device, and that the maximum electric power efficiency is not always achieved at a usage rate of 100% and there are also servers having maximum electric power efficiency at a usage rate of about 60 to 70% (see NPL 2).

### CITATION LIST

### Non Patent Literature

[NPL 1] Kubernetes, “Horizontal Pod Autoscaler Walkthrough,” [online], [accessed on Nov. 1, 2021], the Internet <URL:https://kubernetes.io/ja/docs/tasks/run-application/horizontal-pod-autoscale-walkthrough/>
[NPL 2] C. Jiang, et al., “Energy Proportional Servers: Where Are We in 2016?,” [online], 2017 IEEE 37th International Conference on Distributed Computing Systems, [accessed on Nov. 1, 2021], the Internet <URL:https://ieeexplore.ieee.org/document/7980102>

### SUMMARY OF INVENTION

### Technical Problem

To address the above problem of power consumption by servers and the like, virtualization platforms on the market are equipped with autoscaling (a function of automatically adjusting the number of VMs or the number of containers on the basis of the usage status of a system). However, the thresholds of scaling are determined using values set by a system operator in advance and do not take into consideration the electric power efficiency characteristics of each piece of hardware. In particular, even in a case where multiple servers of multiple types (for example, heterogeneous hardware including accelerators such as a GPU and an FPGA) are abstracted as physical resources through virtualization technology, heterogeneous environments in which there are differences in the performance and electric power efficiency characteristics of each server are not considered.

For example, in Kubernetes mentioned above, autoscaling is realized with a function called a horizontal pod autoscaler (HPA), but metrics (evaluation scales) used for scaling determination are not calculated in consideration of heterogeneous environments.

Specifically, the HPA uses, for example, a CPU usage rate as a metric for Pod (minimum execution unit of a Kubernetes application) participating in a cluster, and compares the average value of the CPU usage rate with a threshold to determine the presence or absence of scaling. In this case, the CPU usage rate does not take into consideration the difference in performance of hardware (hereinafter sometimes referred to as “HW”) (the difference in processing performance of each server) or the difference in electric power efficiency characteristics (the difference in a usage rate at which electric power efficiency becomes maximum).

Here, it is assumed that, in a cloud platform (virtualization platform) with an HW_A and an HW_B as physical resources, an operator of this system has input a requested resource “800 m” (“m” is a unit expressed as 1 core=1,000 millicores in Kubernetes) to a resource config file of Pod, and has input a scaling threshold “CPU usage rate=60%” to a config file related to scaling. In addition, as shown in FIG. 11, the performance ratio between the HW_A and the HW_B is set to “2:1,” according to the electric power efficiency characteristics of the HW_A, electric power efficiency becomes maximum at a usage rate of 901, and according to the electric power efficiency characteristics of the HW_B, electric power efficiency becomes maximum at a usage rate of 60%. Further, it is assumed that the HW_A and the HW_B each have the same Pod number of “1” and the same scaling threshold (60%).

It is assumed that the cloud platform is operated with the above settings, and the average usage rate of Pod is “400 m” for the HW_A and “800 m” for the HW_B as shown in FIG. 11. The execution determination of scaling in this case is as follows. The average CPU usage rate of Pod . . . (400 m+800 m)/2=600 m On the other hand, the scaling threshold is “CPU usage rate=60%,” and thus 800 m×0.6=480 m. Thus, since the average CPU usage rate “600 m” of Pod exceeds the scaling threshold “480 m,” scaling is executed and one Pod is added.

In this way, since HW performance differences and electric power efficiency characteristic differences are not considered, Pod is added in spite of there still being room for the Pod of the HW_A.

The present invention was contrived in view of such points, and an object of the present invention is to make it possible to efficiently operate resources with reduced power consumption in a virtualization platform.

### Solution to Problem

According to the present invention, there is provided a scaling management device configured to manage scaling of virtual resources mounted on hardware through a virtualization platform, the scaling management device including: an electric power efficiency characteristic calculation unit configured to calculate electric power efficiency characteristics of each of a plurality of pieces of the hardware by measuring electric power efficiency of the hardware while varying a level of a usage rate of the hardware, and determine a usage rate at which a value of electric power efficiency is highest among the measured electric power efficiencies; a performance ratio calculation unit configured to measure performance of each piece of hardware by measuring a predetermined metric, identify the hardware having a lowest performance value, and calculate a performance value of other hardware as a performance ratio in a case where a performance value of the identified hardware is set to 1; a virtual resource number calculation unit configured to calculate a score obtained by multiplying the calculated performance ratio by the usage rate at which the value of electric power efficiency is highest for each piece of hardware, and calculate the number of virtual resources to be mounted on the hardware in accordance with a ratio of magnitude of the score calculated for each piece of hardware; a requested resource calculation unit configured to calculate requested resources for the virtual resources to be mounted on the hardware having a lowest performance value and the other hardware by setting the requested resource of the hardware having a lowest performance value to a value indicated by the performance ratio to 1 in a case where the requested resource for the virtual resource to be mounted on the other hardware is set to 1 on the basis of the performance ratio of the other hardware to the performance value 1 of the hardware having a lowest performance value; and a config file creation unit configured to create a scaling config file for each piece of hardware with the usage rate at which the value of electric power efficiency is highest as a target value of scaling of the hardware, and create a resource config file including the calculated number of virtual resources to be mounted on the hardware and the requested resources of the virtual resources to be mounted on the hardware.

### Advantageous Effects of Invention

According to the present invention, it is possible to efficiently operate resources with reduced power consumption in a virtualization platform.

### BRIEF DESCRIPTION OF DRAWINGS

FIG. 1 is a diagram illustrating an overview of processing which is executed by a scaling management device according to the present embodiment.

FIG. 2 is a diagram illustrating an overall configuration of a scaling management system including the scaling management device according to the present embodiment.

FIG. 3 is a diagram illustrating calculation results of electric power efficiency characteristics of hardware according to the present embodiment.

FIG. 4 is a diagram illustrating calculation results of the performance ratio of the hardware according to the present embodiment.

FIG. 5 is a flowchart illustrating a flow of processing of calculating electric power efficiency characteristics according to the present embodiment.

FIG. 6 is a flowchart illustrating a flow of performance ratio calculation processing according to the present embodiment.

FIG. 7 is a flowchart illustrating of a flow of scaling processing according to the present embodiment.

FIG. 8 is a flowchart illustrating a flow of scaling processing according to the present embodiment.

FIG. 9 is a flowchart illustrating a flow of startup/stop processing of the hardware according to the present embodiment.

FIG. 10 is a hardware configuration diagram illustrating an example of a computer that realizes functions of the scaling management device according to the present embodiment.

FIG. 11 is a diagram illustrating a problem of scaling in a virtualization platform in which conventional heterogeneous hardware is mixed and operated.

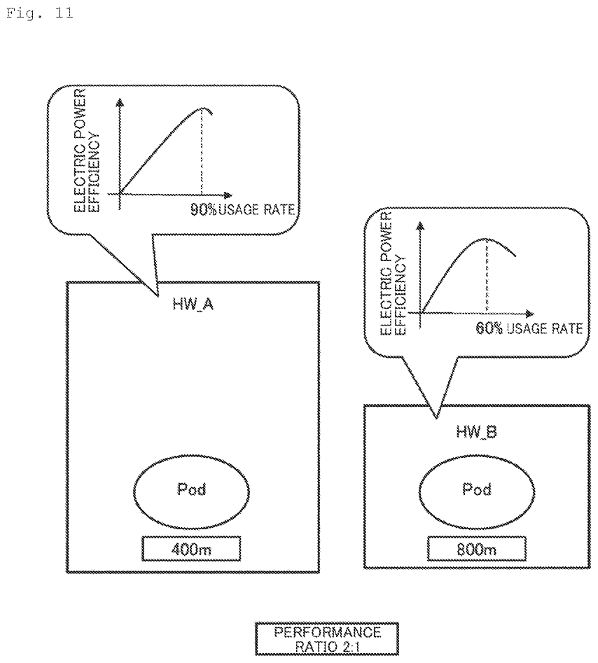

### DESCRIPTION OF EMBODIMENTS

Next, a mode for carrying out the present invention (hereinafter referred to as “the present embodiment”) will be described. First, an overview of processing which is executed by a scaling management device 10 according to the present embodiment will be described.

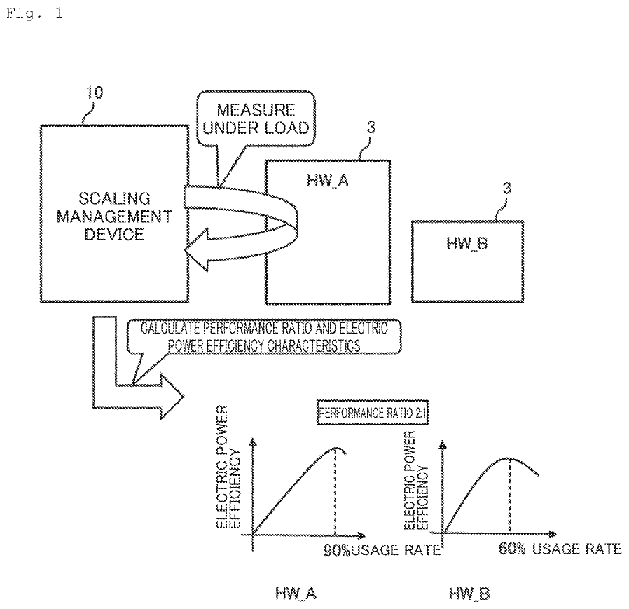

FIG. 1 is a diagram illustrating an overview of processing which is executed by the scaling management device 10 according to the present embodiment.

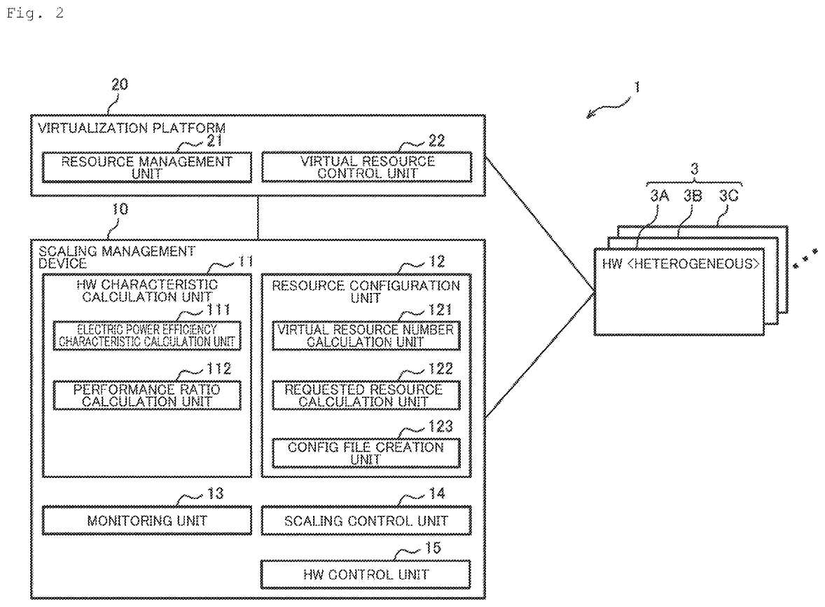

The scaling management device 10 calculates setting values of requested resources and thresholds of scaling in consideration of performance differences or electric power efficiency characteristic differences with respect to a plurality of pieces of hardware 3 (HW_A and HW_B in FIG. 1) which are set and managed by a virtualization platform 20 (see FIG. 2 to be described later).

This scaling management device 10 executes the following processes.

<1> A benchmark tool or the like is used to calculate a performance difference and electric power efficiency characteristics for each piece of hardware.

Here, for the performance difference, the ratio between the performance values of each piece of hardware when the performance value of hardware with the lowest performance among a plurality of pieces of hardware is set to “1” is calculated as a performance ratio. For example, the performance ratio between the HW_A and the HW_B is calculated as “2:1.”

In addition, using a benchmark tool, the load is gradually applied and measured to calculate electric power efficiency characteristics in each piece of hardware and obtain a usage rate at which electric power efficiency becomes maximum. As shown in FIG. 1, the electric power efficiency becomes maximum in the HW_A when the usage rate is “903.” In addition, the electric power efficiency becomes maximum in the HW_B when the usage rate is “60%.”

<2> The number of virtual resources to be mounted on each piece of hardware (the number of virtual resources) is calculated.

First, a usage rate corresponding to the maximum value of electric power efficiency in the electric power efficiency characteristics of each piece of hardware is set as a target value of scaling. Here, in the HW_A, the target value of electric power efficiency is a usage rate of “90%.” In the HW_B, the target value of electric power efficiency is a usage rate of “60%.”

The score of each piece of hardware is calculated based on the target value of electric power efficiency and the performance ratio of “2:1.”
the score of the HW_A . . . performance “2”×electric power efficiency “90%”=1.8
The score of the HW_B . . . performance “1”×electric power efficiency “60%”=0.6

The number of virtual resources (such as containers or VMs) to be mounted on each piece of hardware is calculated on the basis of this score ratio. Meanwhile, in the present specification, an application virtualized on a virtualization platform (composed of one or more containers, one or more VMs, and the like) is referred to as a virtual resource, and the number of virtual resources means the number of containers or the number of VMs. In addition, in the following description, a virtual resource which is set in a virtualization platform will be described as a container, but there is no limitation thereto.

Here, the number of containers mounted on the hardware is assumed to be “3:1” with HW_A:HW_B corresponding to a score ratio of “1.8:0.6.” That is, for example, it is assumed that three virtual resources are mounted on the HW_A and that one virtual resource is mounted on the HW_B.

<3> Requested resources are set so that performance in units of containers is the same.

In a case where the performance ratio between the HW_A and the HW_B is “2:1” as described above, for example, the requested resource “800 m” for the container mounted on the HW_B is set with respect to the requested resource “400 m” for the container mounted on the HW_A. That is, the requested resources are set so that the ratio of the requested resources between the HW_A and the HW_B is “1:2.”

A resource config file needed during deployment of containers and a scaling config file needed during execution of scaling are created on the basis of the above calculation results. Here, the following are set in the resource config file: the number of containers mounted on the hardware as well as requested resources for the containers mounted on the hardware, for example, a requested resource “400 m” for the containers mounted on the HW_A and a requested resource “800 m” for the containers mounted on the HW_B.

In addition, in the scaling config file, the target value of scaling is set to a usage rate of “90-” on the basis of the electric power efficiency characteristics in the HW_A, and the target value of scaling is set to a usage rate of “60%” on the basis of the electric power efficiency characteristics in the HW_B.

<4> During operation, scaling is executed on the basis of the scaling config file.

During operation, the usage status (usage rate) of the container is monitored to execute scaling on the basis of the scaling config file. At this time, determination is made with a different target value for each hardware type. In a case where the usage rate of the hardware is remarkably high or low, the hardware itself is started up or stopped.

This scaling management device 10 creates a resource config file (specifically, setting the number of containers to be mounted for each piece of hardware and setting of a requested resource to be allocated) in consideration of the performance difference (performance ratio) and the electric power efficiency characteristic difference (the difference in the usage rate at which electric power efficiency becomes maximum). Therefore, when traffic is equally distributed to all containers by a load balancer or the like, all hardware will reach the scaling threshold almost simultaneously. Meanwhile, the scaling management device 10 performs container monitoring and scaling determination, whereas the virtualization platform 20 (FIG. 2) performs actual container control.

The scaling management device 10 according to the present embodiment can perform control to operate with a load amount having the highest electric power efficiency for each piece of hardware on the virtualization platform by creating a resource config file in consideration of the performance difference (performance ratio) and setting the target value (threshold) of scaling in consideration of the electric power efficiency characteristic difference. Meanwhile, the virtualization platform to be controlled by the scaling management device 10 is particularly useful in a heterogeneous environment in which heterogeneous hardware is mixed, but may be configured with the same type of hardware. In the following description, it is assumed that the hardware is configured in a heterogeneous environment consisting of multiple units of multiple types. Hereinafter, a scaling management system 1 including the scaling management device 10 of the present invention will be described in detail.

FIG. 2 is a diagram illustrating an overall configuration of the scaling management system 1 including the scaling management device 10 according to the present embodiment. The scaling management system 1 is configured to include hardware (HW) 3(3A, 3B, 3C, . . . ) which is a physical resource consisting of multiple servers of multiple types, the virtualization platform 20 that virtualizes heterogeneous hardware 3 which is a physical resource using virtualization technology and constructs a common platform for providing a plurality of applications and services using virtual resources (such as containers and VMs) set on each piece of hardware 3, and the scaling management device 10 communicatively connected to each piece of hardware 3 and the virtualization platform 20.

The hardware 3 is, for example, heterogeneous hardware including accelerators such as a GPU and an FPGA. The hardware 3 of the present embodiment is composed of a plurality of pieces of hardware with at least different electric power efficiency characteristics.

The virtualization platform 20 abstracts and conceals physical resources such as the hardware 3 using virtualization technology, and manages a virtualized environment in which a plurality of applications and services are constructed as a common platform. This virtualization platform 20 is realized by, for example, a server or the like provided on the cloud. As shown in FIG. 2, the virtualization platform 20 includes a resource management unit 21 and a virtual resource control unit 22. The resource management unit 21 sets and manages physical resources such as the hardware 3. The virtual resource control unit 22 sets and manages virtual resources (containers and VMs) to be constructed (mounted) on the hardware 3.

The virtual resource control unit 22 of this virtualization platform 20 mounts virtual resources (such as containers) in each piece of hardware 3 on the basis of the number of virtual resources indicated by the resource config file acquired from the scaling management device 10. In addition, the virtual resource control unit 22 adjusts (adds/deletes) virtual resources on the basis of a request from the scaling management device 10.

In addition, when an instruction to start up and stop the hardware 3 is received from the scaling management device, the resource management unit 21 starts up and stops the hardware 3 which is a physical resource on the basis of the usage status of the hardware 3.

### <Scaling Management Device>

The scaling management device 10 calculates the number of virtual resources to be constructed in each piece of hardware 3 on the basis of the electric power efficiency characteristics of each piece of hardware 3 and the performance difference (performance ratio) between the pieces of hardware 3, then sets a scaling policy, and executes scaling of the virtual resources constructed in the hardware 3 through the virtualization platform 20.

This scaling management device 10 is constituted by a computer including a control unit, an input and output unit, and a storage unit (all of which are not shown).

The input and output unit inputs and outputs information to and from the virtualization platform 20, each piece of hardware 3, and the like. This input and output unit is constituted by a communication interface for transmitting and receiving information through a communication line and an input and output interface for inputting and outputting information between an input device such as a keyboard and an output device such as a monitor (not shown).

The storage unit is constituted by a hard disk, a flash memory, a random access memory (RAM), or the like.

This storage unit temporarily stores a program for executing each function of the control unit and information necessary for processing of the control unit.

The control unit is responsible for the overall processing executed by the scaling management device 10, and is configured to include an HW characteristic calculation unit 11, a resource configuration unit 12, a monitoring unit 13, a scaling control unit 14, and an HW control unit 15.

The HW characteristic calculation unit 11 calculates the performance difference (performance ratio) and the electric power efficiency characteristics for each piece of hardware 3 using a benchmark tool or the like. This HW characteristic calculation unit 11 is configured to include an electric power efficiency characteristic calculation unit 111 and a performance ratio calculation unit 112.

The electric power efficiency characteristic calculation unit 111 calculates the electric power efficiency characteristics of each piece of hardware 3 by measuring the electric power efficiency of the hardware 3 while varying the level of a usage rate of the hardware 3, and determines the usage rate at which the value of electric power efficiency is highest among the measured electric power efficiencies.

Specifically, the electric power efficiency characteristic calculation unit 111 first applies a benchmark load to the hardware 3 and calculates the maximum RPS (requests per second). For example, “5000” is calculated as the maximum RPS (RPS_MAX). Meanwhile, the electric power efficiency characteristic calculation unit 111 stores the maximum RPS value of each piece of hardware 3 in the storage unit. Next, the electric power efficiency characteristic calculation unit 111 applies the maximum load of the hardware 3 in increments of 10% for a predetermined time T (any value set in advance, for example, T seconds). The electric power efficiency characteristic calculation unit 111 then calculates the average electric power (Power_x[W]) and the average load (RPS_x) in a predetermined time T. In addition, the electric power efficiency characteristic calculation unit 111 calculates the average electric power for the predetermined time T in a state where no load is applied.

Next, the electric power efficiency characteristic calculation unit 111 uses the calculated average electric power (Power_x[W]) and average load (RPS_x) to calculate electric power efficiency (EE_x) on the basis of the formula “electric power efficiency=average load/average electric power.” Further, the electric power efficiency characteristic calculation unit 111 calculates a value (normalized EENormalize_x) obtained by normalizing the electric power efficiency calculated in increments of 10% of the load with the electric power efficiency at the maximum RPS as “1.0.”

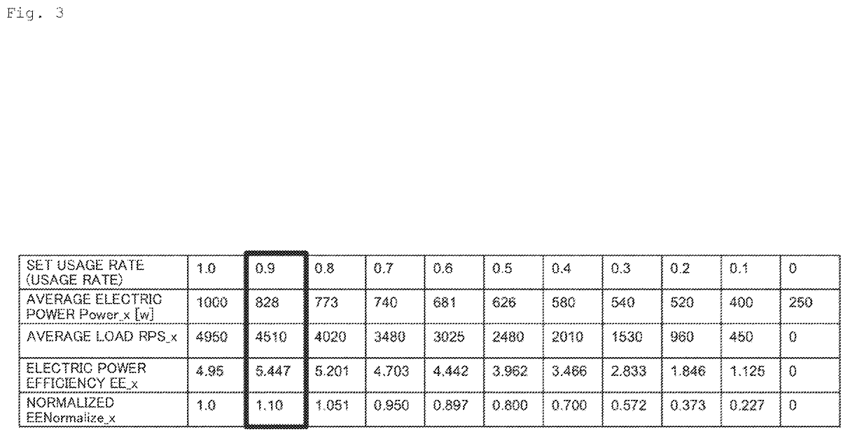

FIG. 3 is a diagram illustrating calculation results of the electric power efficiency characteristics of the hardware 3 according to the present embodiment.

The first row in FIG. 3 indicates the resource usage rate with the load set in increments of 10% in a case where the maximum processing amount (load) is set to “1.0.” This usage rate is hereinafter referred to as the “set usage rate” to distinguish it from the usage rate measured by monitoring the hardware 3. The electric power efficiency EE_x in the fourth row is a value obtained by dividing the average load RPS_x in the third row by the average electric power Power_x[W] in the second row. The normalized EENormalize_x in the fifth row is a value obtained by normalizing the electric power efficiency at each set usage rate (0.9 to 0.1) with the electric power efficiency (“4.95” in FIG. 3) at the maximum RPS (“4950” in FIG. 3) as “1.0.”

In FIG. 3, when the set usage rate (usage rate) is “0.9” (90%), the normalized value is “1.10” which is the highest.

Thus, this hardware 3 has the highest electric power efficiency EE_x when the usage rate is “0.9” (90%).

Meanwhile, the electric power efficiency characteristic calculation unit 111 is not limited to calculating the electric power efficiency characteristics by applying a benchmark load, and may use other methods. For example, the electric power efficiency characteristic calculation unit 111 may measure the electric power efficiency and the usage rate during operation using an application actually installed in the hardware 3 without applying a benchmark load, and calculate (learn) the optimum value of the usage rate at which electric power efficiency becomes maximum.

Referring back to FIG. 2, the performance ratio calculation unit 112 measures the performance of each piece of hardware 3 by measuring a predetermined metric, identifies the hardware 3 having the lowest performance value, and calculates the performance value of the other hardware 3 as a performance ratio in a case where the performance value of the identified hardware 3 is set to “1.”

Specifically, the performance ratio calculation unit 112 first refers to information on the maximum RPS of each piece of hardware 3 calculated by the electric power efficiency characteristic calculation unit 111, and selects the RPS value of the hardware 3 with the lowest value of the maximum RPS.

Next, the performance ratio calculation unit 112 applies a load in increments of 10% of the selected RPS value for a predetermined time T (any value set in advance). An average usage rate (such as, for example, a CPU usage rate or a GPU usage rate) for each predetermined time T is then calculated.

The performance ratio calculation unit 112 measures the average usage rate for all hardware types.

The performance ratio calculation unit 112 then calculates the performance score by calculating the ratio of the average usage rate of the other hardware 3 to the average usage rate of the hardware 3 with the lowest RPS value in increments of 10% of the load and averaging them as a whole.

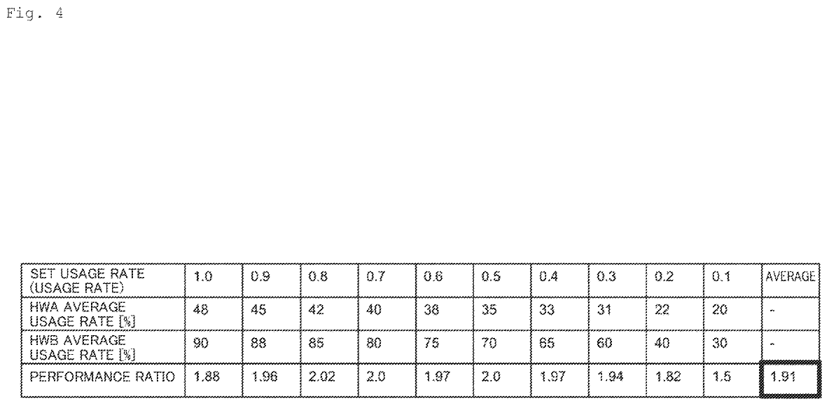

FIG. 4 is a diagram illustrating calculation results of the performance ratio of the hardware 3 according to the present embodiment.

The set usage rate (usage rate) in the first row in FIG. 4 indicates the resource usage rate in increments of 10% in a case where the RPS value of the hardware 3 with the lowest value of the maximum RPS is set to “1.0.” The third row indicates the average usage rate [%] of the HW_B which is the hardware 3 with the lowest value of the maximum RPS. In addition, the second row indicates the average usage rate [%] of the HW_A which is the other hardware 3. The performance ratio in the fourth row is a value obtained by dividing the average usage rate [%] of the HW_B which is the hardware 3 with the lowest value of the maximum RPS in the third row by the average usage rate [%] of the HW_A which is the other hardware 3 in the second row for each set usage rate (1.0 to 0.1).

The performance ratio calculation unit 112 than calculates the average of the performance ratios at each set usage rate on the basis of this calculation result (“1.91” in FIG. 4). That is, the performance ratio between the HW_A and the HW_B is approximately “2:1.” Meanwhile, the performance ratio calculation unit 112 sets the performance score of the HW_A to “2” and sets the performance score of the HW_B to “1” on the basis of this performance ratio.

Here, the performance ratio calculation unit 112 calculates the performance ratio by calculating the performance ratio of the average usage rate between the hardware 3. This is because the determination of scaling performed by the scaling control unit 14 (FIG. 2) to be described later is performed on the basis of the usage rate, so that a more accurate value can be obtained by calculating the performance ratio on the basis of the ratio of the usage rate as well. However, the calculation of this performance ratio is not limited to a method based on this usage rate. For example, the performance ratio calculation unit 112 may calculate the ratio of the RPS value of the hardware 3 with the lowest value of the maximum RPS to the maximum RPS value of the other hardware 3 to be compared, as the performance ratio.

Meanwhile, in a case where the hardware 3 is composed of a plurality of pieces of hardware 3 of the same type, the measured performance values are basically the same as each other. At this time, the performance ratio calculation unit 112 specifies one of the plurality of pieces of hardware 3 as the hardware 3 having the lowest performance value, compares it with the performance value of the other hardware 3, and calculates the performance ratio “1:1.” In addition, the scaling management device 10 may acquire, in advance, information indicating that the performance ratio of each piece of hardware 3 is “1:1” from a system management terminal or the like, and the performance ratio calculation unit 112 may hold the information.

Referring back to FIG. 2, the resource configuration unit 12 calculates the number of virtual resources (such as containers) to be mounted on each piece of hardware 3, and sets the requested resources so that the performance in units of virtual resources is the same.

This resource configuration unit 12 is configured to include a virtual resource number calculation unit 121, a requested resource calculation unit 122, and a config file creation unit 123.

The virtual resource number calculation unit 121 calculates a score obtained by multiplying the performance ratio calculated by the performance ratio calculation unit 112 by the usage rate at which the value of electric power efficiency is highest for each piece of hardware 3, and calculates the number of virtual resources to be mounted on the hardware 3 in accordance with the ratio of the magnitude of the score calculated for each piece of hardware 3.

Specifically, the virtual resource number calculation unit 121 calculates a score by multiplying the performance score of each piece of hardware 3 calculated by the performance ratio calculation unit 112 by the set usage rate (usage rate) at which electric power efficiency indicated by the electric power efficiency characteristics is highest.

The score of the HW_A . . . performance score “2”×usage rate of highest electric power efficiency “90%”=1.8 The score of the HW_B . . . performance score “1”×usage rate of highest electric power efficiency “60%”=0.6 The virtual resource number calculation unit 121 sets the number of containers mounted on the hardware 3 to “3:1” in HW_A:HW_B on the basis of this score ratio.

Meanwhile, in a case where the ratio of HW_A:HW_B is not an integer, for example, like “2.5:1,” the virtual resource number calculation unit 121 sets logic such as rounding off the number to the first decimal place in advance so that the number of containers can be calculated as an integer.

In addition, in a case where the hardware 3 is composed of a plurality of pieces of hardware 3 of the same type, each piece of hardware 3 has the same performance score of “1” and the same usage rate of the highest electric power efficiency. Thus, the virtual resource number calculation unit 121 sets the number of containers mounted on each piece of hardware 3 to “1:1.”

The requested resource calculation unit 122 sets the requested resources to be set for each piece of hardware 3 so that the performance in units of virtual resources is the same on the basis of the performance ratio calculated by the performance ratio calculation unit 112.

Here, using the performance ratio of the other hardware to the performance value “1” of the hardware 3 having the lowest performance value, the requested resource calculation unit 122 sets the requested resource of the hardware 3 having the lowest performance value to a value indicated by the performance ratio to “1” in a case where the requested resource for the virtual resource mounted on the other hardware 3 is set to “1.” The requested resources for the virtual resources mounted on the hardware 3 having the lowest performance value and the other hardware 3 are calculated on the basis of this.

Specifically, in a case where the performance ratio between the HW_A and the HW_B is “2:1” as described above, the requested resource calculation unit 122 sets, for example, the requested resource “400 m” of the HW_A to the requested resource “800 m” of the HW_B. That is, the requested resources are determined so that the ratio of requested resources between the HW_A and the HW_B is “1:2” which is the opposite of the performance ratio.

Meanwhile, in a case where the hardware 3 is composed of a plurality of pieces of hardware 3 of the same type, the requested resource calculation unit 122 specifies the performance value of one of the plurality of pieces of hardware 3 as the lowest performance value, compares it with the performance value of the other hardware 3, and determines the ratio of the requested resources to be “1:1.”

The config file creation unit 123 creates a scaling config file for each piece of hardware 3 with the usage rate at which the value of electric power efficiency is highest as a target value of scaling of the hardware 3. In addition, the config file creation unit 123 creates a resource config file including the number of virtual resources to be mounted on the hardware 3 calculated by the virtual resource number calculation unit 121 and the requested resources of the virtual resources to be mounted on the hardware 3 calculated by the requested resource calculation unit 122.

The config file creation unit 123 determines the target value of scaling in accordance with the set usage rate (usage rate) of the peak value of electric power efficiency indicated by the electric power efficiency characteristics of the hardware 3. For example, the config file creation unit 123 determines the usage rate to be 90% for the HW_A and the usage rate to be 60% for the HW_B. The config file creation unit 123 creates a scaling config file including information on the determined target value of scaling.

In addition, the config file creation unit 123 creates a resource config file including the number of virtual resources (for example, the number of containers) calculated by the virtual resource number calculation unit 121 and the requested resources (for example, the requested resource “400 m” of the HW_A and the requested resource “800 m” of the HW_B) for the virtual resources (containers) to be mounted on each piece of hardware 3.

The config file creation unit 123 transmits the created resource config file to the virtualization platform 20. Thereby, virtual resources (such as containers) are set in each piece of hardware 3 by the resource management unit 21 of the virtualization platform 20 on the basis of the resource config file.

The monitoring unit 13 monitors each piece of hardware 3 by acquiring information on the usage rate (predetermined metrics such as a CPU usage rate or a GPU usage rate) of the virtual resource (container) at predetermined intervals. The monitoring unit 13 may acquire this information on the usage rate directly from each piece of hardware 3, or may acquire it through the virtualization platform 20.

When the information on the usage rate for each piece of hardware 3 is acquired, the monitoring unit 13 outputs the information to the scaling control unit 14 and the HW control unit 15.

The scaling control unit 14 compares, at predetermined intervals, the differences between the target value of the usage rate based on the electric power efficiency characteristics in each piece of hardware 3 set in the scaling config file and the usage rate acquired by the monitoring unit 13, and executes scaling processing.

Specifically, the scaling control unit 14 acquires information on the usage rate (such as, for example, a CPU usage rate or RPS) of virtual resources such as containers and VMs from the monitoring unit 13. The scaling control unit 14 then calculates a moving average at predetermined intervals (monitoring intervals), averages the virtual resources (for example, the number of containers) mounted on each piece of hardware 3, and compares it with the target value.

In a case where the target value is exceeded, the scaling control unit 14 scales out, that is, adds a virtual resource such as a container. On the other hand, in the case of falling below the target value, the monitoring unit 13 scales in, that is, deletes the virtual resource such as a container.

Meanwhile, when scaling is determined, the scaling control unit 14 may set the number of comparisons with the target value or provide a range with the target value for each scale-out/scale-in. For example, the scaling control unit 14 sets the number of comparisons to one in the determination of scale-out, and adds a container when it is equal to or greater than one (that is, when it exceeds the target value even once). In addition, the monitoring unit 13 sets the number of comparisons to three in the determination of scale-in, and deletes the container when it falls below the target value three consecutive times and 10% below the target value.

When the number of virtual resources to be added or deleted is determined, the scaling control unit 14 transmits the information to the virtualization platform 20 as a container addition/deletion request. Thereby, the virtual resource control unit 22 of the virtualization platform 20 executes addition and deletion of virtual resources mounted on the hardware 3.

The HW control unit (hardware control unit) 15 acquires information on the usage rate (CPU usage rate or GPU usage rate) of the hardware 3, selects one resource from HW resources that have not been started up in a case where the usage rate is remarkably high (higher than a predetermined threshold (first threshold)) or a case where a container addition failure response due to resource shortage is received in response to a container addition request to the virtualization platform 20 by the scaling control unit 14, starts up the hardware 3, and adds a free resource to the resource management unit 21 of the virtualization platform 20.

The HW resource selected by this HW control unit 15 selects the hardware 3 on the basis of the following predetermined policy in order to minimize power consumption.
(1) Select hardware with low maximum power consumption.
(2) Select hardware with low standby power in idle state (standby state).

In the cases of (1) and (2), the performance is generally low, and thus the hardware also has a small maximum RPS.
(3) Select hardware based on increasing traffic trend.

In the case of (3), when the increasing traffic trend is large, hardware with high maximum power consumption but high performance is selected. On the other hand, when the increasing trend is gradual, hardware with low maximum power consumption is selected. Meanwhile, the HW control unit 15 may select a plurality of pieces of hardware instead of limiting the number of units to one in accordance with the increasing trend.

In addition, the HW control unit 15 acquires information on the usage rate (CPU usage rate or GPU usage rate) of the hardware 3, and terminates the hardware 3 serving as a surplus resource in a case where the usage rate is remarkably low (lower than a predetermined threshold (second threshold)).

In this case, the HW control unit 15 selects one piece of hardware 3 in operation and instructs the virtualization platform 20 to stop allocating new processes to virtual resources such as containers which are in operation on the selected hardware 3. The HW control unit 15 then instructs the resource management unit 2 of the virtualization platform 20 to delete the resource information of the hardware 3 and stop processing of the hardware 3 at a timing when all the processes being executed are completed.

Meanwhile, as the HW resource selected by the HW control unit 15, the hardware 3 is selected on the basis of the following predetermined policy in order to minimize power consumption.

(1) Select hardware with large maximum power consumption.

(2) Select hardware with high standby power in idle state (standby state).

In the cases of (1) and (2), the performance is generally high, and thus the hardware also has a large maximum RPS.

(3) Select hardware based on decreasing traffic trend.

In the case of (3), when the decreasing traffic trend is large, hardware with high maximum power consumption and high performance is selected. On the other hand, when the decreasing trend is gradual, hardware with low maximum power consumption is selected. Meanwhile, the HW control unit 15 may select a plurality of pieces of hardware instead of limiting the number of units to one in accordance with the decreasing trend.

Meanwhile, the HW control unit 15 has been described as performing startup and stop of the hardware 3 through the resource management unit 21 of the virtualization platform 20, but the HW control unit 15 may directly instruct the selected hardware 3 to start up and stop without going through the virtualization platform 20.

### <Processing of Scaling Management Device>

Next, a flow of processing which is executed by the scaling management device 10 according to the present embodiment will be described in detail.

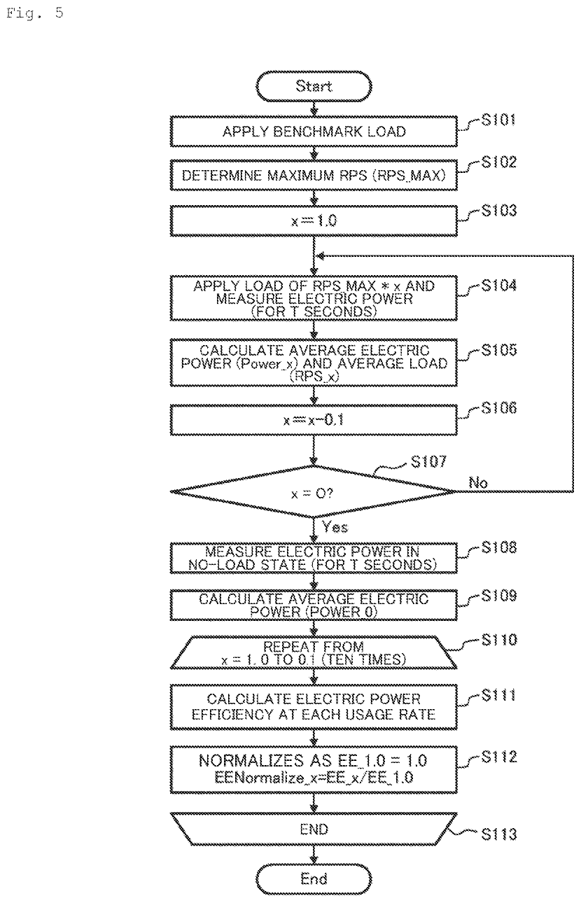

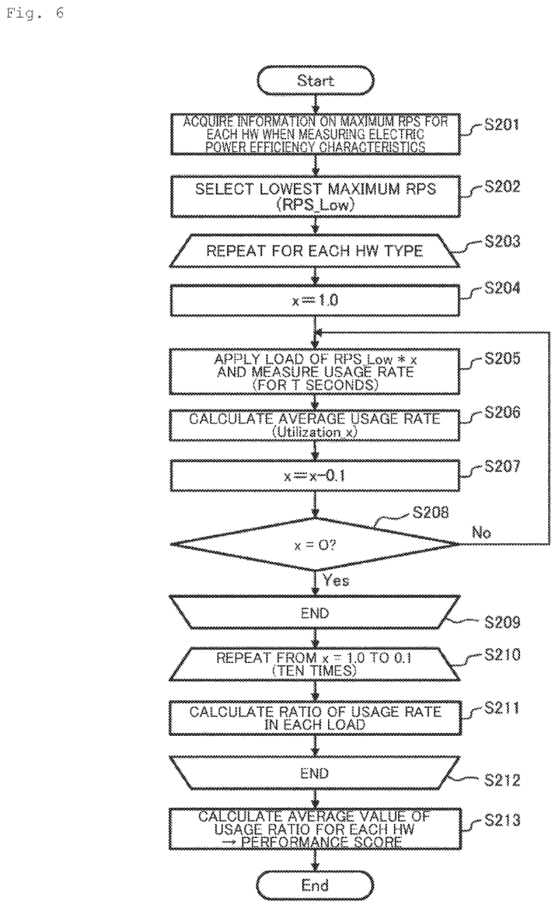

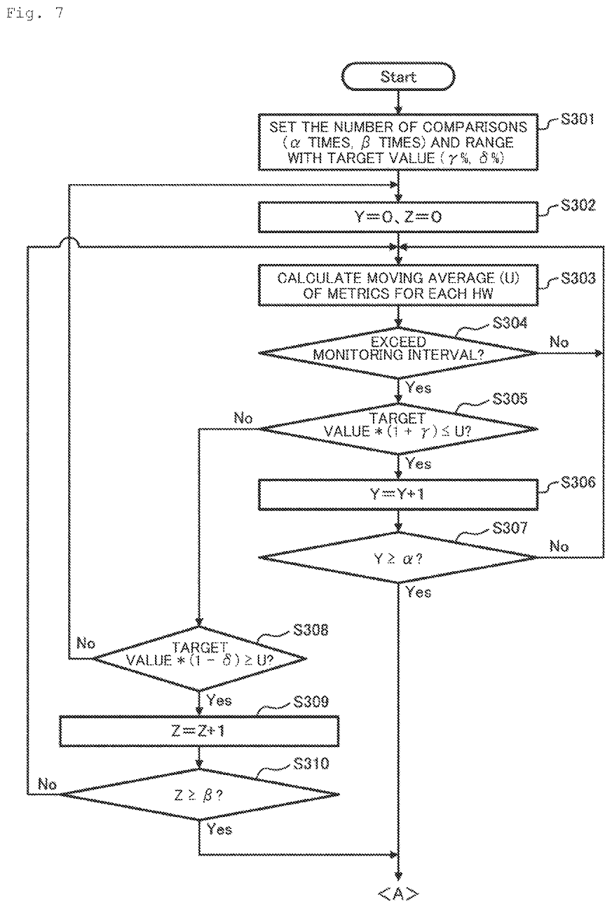

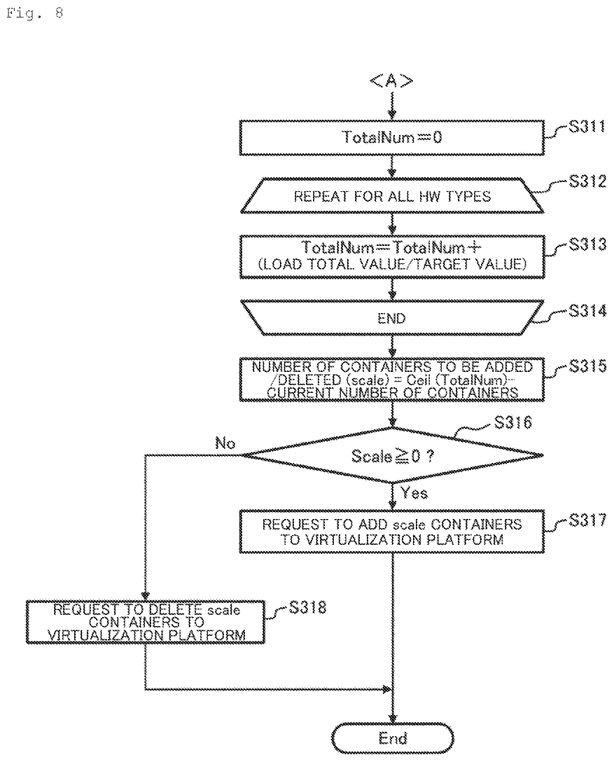

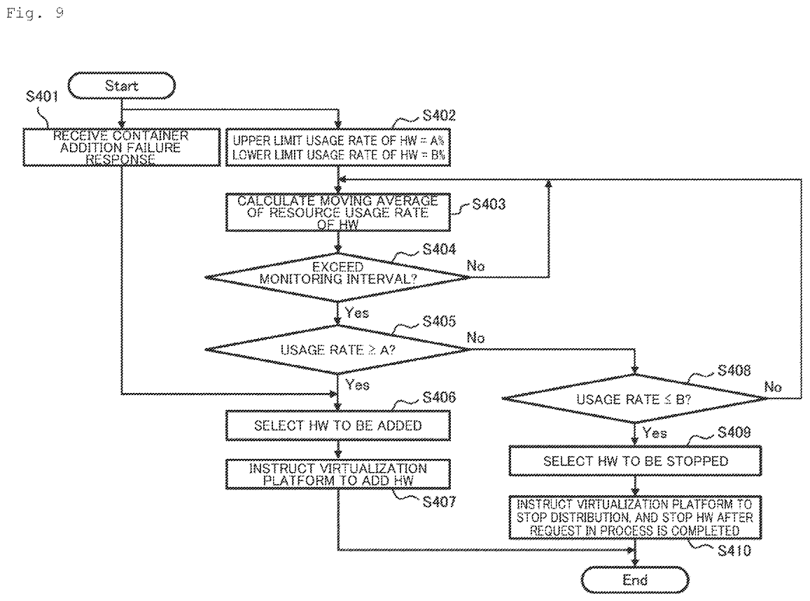

Here, processing of calculating electric power efficiency characteristics (FIG. 5), performance ratio calculation processing (FIG. 6), scaling processing (FIGS. 7 and 8), and hardware startup/stop processing (FIG. 9) which are executed by the scaling management device 10 will be described in detail.

### <<Processing of Calculating Electric Power Efficiency Characteristic>>

FIG. 5 is a flowchart illustrating a flow of processing of calculating electric power efficiency characteristics according to the present embodiment.

First, the electric power efficiency characteristic calculation unit 111 of the scaling management device 10 applies a benchmark load to each piece of hardware 3 (step S101).

The electric power efficiency characteristic calculation unit 111 then determines the maximum RPS for each piece of hardware 3 (step S102). Meanwhile, the electric power efficiency characteristic calculation unit 111 stores the maximum RPS of each piece of hardware 3 in the storage unit.

The electric power efficiency characteristic calculation unit 111 then sets “x=1.0” for the usage rate (set usage rate)×at the maximum RPS (step S103).

Next, the electric power efficiency characteristic calculation unit 111 applies a load of maximum RPS x “x” to the hardware 3, and measures the electric power for a predetermined time (for example, T seconds) (step S104).

Next, the electric power efficiency characteristic calculation unit 111 calculates the average electric power (Power_x) and the average load (RPS_x) for a predetermined time (T seconds) (step S105).

The electric power efficiency characteristic calculation unit 111 then sets the usage rate x to “x=x−0.1” in order to apply the maximum load of the hardware 3 in increments of 10% (step S106).

Next, the electric power efficiency characteristic calculation unit 111 determines whether “x=0” (step S107), and if the relation of x=0 is not established (step S107→No), it returns to step S104 and continues the processing. On the other hand, if x=0 (step S107→Yes), the process proceeds to the next step S108.

In step S108, the electric power efficiency characteristic calculation unit 111 measures the electric power for a predetermined time (T seconds) in a state where no load is applied (no-load state).

The electric power efficiency characteristic calculation unit 111 then calculates the average electric power (Power_0) in the no-load state (step S109).

Meanwhile, through these processes of steps S101 to S109, the electric power efficiency characteristic calculation unit 111 obtains information on the average electric power (Power_x) and the average load (RPS_x) shown in FIG. 3.

Next, the electric power efficiency characteristic calculation unit 111 repeats the processing from 1.0 to 0.1 ten times for the usage rate (set usage rate) x (steps S110 to S113).

In step S111, the electric power efficiency characteristic calculation unit 111 calculates the electric power efficiency (EE_x) at each usage rate x on the basis of the formula “electric power efficiency=average load/average electric power.”

Next, the electric power efficiency characteristic calculation unit 111 calculates a value (normalized EENormalize_x) obtained by normalizing the electric power efficiency calculated in increments of 10% of the load with the electric power efficiency at the maximum RPS as “1.0.” (step S112). Through these processes of steps S110 to S113, the electric power efficiency characteristic calculation unit 111 obtains information on electric power efficiency (EE_x) and normalization (EENormalize_x) shown in FIG. 3.

The electric power efficiency characteristics indicated by the information on the normalized value (EENormalize_x) in FIG. 3 shows that the electric power efficiency is highest in a case where the normalized value is “1.10” which is highest, that is, when the usage rate (set usage rate) is “0.9” (90%).

### <<Performance Ratio Calculation Process>>

FIG. 6 is a flowchart illustrating a flow of performance ratio calculation processing according to the present embodiment.

First, the performance ratio calculation unit 112 of the scaling management device 10 acquires information on the maximum RPS for each piece of hardware 3 measures when the electric power efficiency characteristic calculation unit 111 calculates the electric power efficiency characteristics (step S201).

The performance ratio calculation unit 112 then selects information on the lowest maximum RPS (RPS_Low) from the acquired information on the maximum RPS (step S202).

Next, the performance ratio calculation unit 112 repeats the processes of steps S203 to S209 for hardware type. At that time, the performance ratio calculation unit 112 sets the selected lowest maximum RPS value to the usage rate “1.0” and applies a load with the maximum RPS value in increments of 10%.

First, the performance ratio calculation unit 112 sets the selected lowest maximum RPS value to the usage rate (set usage rate) x “x=1.0” (step S204).

Next, the performance ratio calculation unit 112 applies a load of the selected lowest maximum RPS× “x” to the hardware 3, and measures the usage rate (for example, CPU usage rate or GPU usage rate) for T seconds which is a predetermined time (step S205).

Next, the performance ratio calculation unit 112 calculates the average usage rate (Utilizatin_x) for a predetermined time (T seconds) (step S206).

The performance ratio calculation unit 112 then sets the usage rate (set usage rate) x to “x=x−0.1” in order to apply the maximum load of the hardware 3 in increments of 10% (step S207).

Next, the performance ratio calculation unit 112 determines whether “x=0” (step S208), and if the relation of x=0 is not established (step S208→No), it returns to step S205 and continues the processing. On the other hand, if x=0 (step S208→Yes), the process proceeds to the next step S209. Meanwhile, by repeating these processes of steps S204 to S208 for each hardware type, the performance ratio calculation unit 112 obtains information on the HW_A average usage rate and the HW_B average usage rate, for example, shown in FIG. 4.

Next, the performance ratio calculation unit 112 repeats the processing from 1.0 to 0.1 ten times for the usage rate (set usage rate)×(steps S210 to S212).

In step S211, the performance ratio calculation unit 112 calculates the ratio of the usage rate at each usage rate (set usage rate) x.

Specifically, the performance ratio calculation unit 112 calculates a value obtained by dividing the average usage rate of the hardware 3 (the HW_B in FIG. 5) with the lowest value of the maximum RPS by the average usage rate of the other hardware 3 to be compared (the HW_A in FIG. 5).

By repeating this process of step S211 at each usage rate (set usage rate) x, the performance ratio calculation unit 112 calculates the performance ratio shown in FIG. 4.

Next, in step S213, the performance ratio calculation unit 112 calculates the average of the performance ratio for the usage rate (set usage rate) x=1.0 to 0.1 (average “1.91” in FIG. 4).

The performance ratio calculation unit 112 sets the performance ratio (HW_A:HW_B) between the other hardware 3 to be compared (the HW_A in FIG. 4) and the hardware 3 with the lowest value of the maximum RPS (the HW_B in FIG. 4) to “1.91:1”≈“2:1.”

Meanwhile, the performance ratio calculation unit 112 sets the performance score of the HW_A to “2” and the performance score of the HW_B to “1” on the basis of this performance ratio.

The performance ratio calculation unit 112 calculates the performance ratio of the hardware 3 with the lowest value of the maximum RPS (the HW_B in FIG. 4) for each piece of hardware 3 with different types to be compared.

### <<Scaling Process>>

FIGS. 7 and 8 are flowcharts illustrating a flow of scaling processing according to the present embodiment.

Meanwhile, it is assumed that when the scaling control unit 14 of the scaling management device 10 executes the scaling processing, the monitoring unit 13 acquires information on a metrics (for example, CPU usage rate, usage rate obtained from RPS or the like) to be monitored for each piece of hardware 3.

In step S301, the scaling control unit 14 first sets the threshold for the number of scale-out determinations to a times, and sets the threshold for the number of scale-in determinations to Q times. In addition, the range with the target value of scale-out determination is set to (y-f), and the range with the target value of scale-in determination is set to (δ%).

Next, in step S302, the scaling control unit 14 sets (initializes) the number of scale-out determinations “Y” to “0.” In addition, the scaling control unit 14 initializes the number of scale-in determinations “Z” to “0”.

The scaling control unit 14 calculates the moving average (U) of metrics at predetermined intervals for each piece of hardware 3 (step S303).

Next, the scaling control unit 14 determines whether the predetermined monitoring interval has been exceeded (step S304). When the predetermined monitoring interval is not exceeded (step S304→No), the process returns to step S303 and continues. On the other hand, when the predetermined monitoring interval is exceeded (step S304→Yes), the process proceeds to the next step S305.

In step S305, the scaling control unit 14 determines whether the moving average (U) of the metrics is equal to or greater than the value of target value×(1+γ). In a case where the value of the moving average (U) is exceeded (step S305→Yes), the process proceeds to step S306, and the number of scale-out determinations “Y” is set to Y+1.

Next, the scaling control unit 14 determines whether the number of scale-out determinations “Y” is equal to or greater than “α” (step S307). Here, when “Y” is not equal to or greater than “α” (step S307→No), the process returns to step S303 and continues. On the other hand, when “Y” is equal to or greater than “a” (step S307→Yes), the process proceeds to step S311 in FIG. 8.

In addition, in step S305, in a case where the moving average (U) of metrics is less than the value of target value×(1+γ) (step S305→No), the scaling control unit 14 determines whether the moving average (U) of metrics is less than the value of target value×(1−δ) (step S308). In a case where the moving average (U) is not less than the value of target value×(1−δ), that is, a case where the moving average (U) is equal to or greater than the value of target value×(1−δ) (step 308→No), the process returns to step S302 and continues. On the other hand, in a case where the moving average (U) is less than the value of target value×(1−δ) (step S308→Yes), the process proceeds to step S309, and the number of scale-in determinations “Z” is set to Z+1.

Next, the scaling control unit 14 determines whether the number of scale-in determinations “Z” is equal to or greater than “β” (step S310). Here, when “Z” is not equal to or greater than “β” (step S310→No), the process returns to step S303 and continues. On the other hand, when “Z” is equal to or greater than “β” (step S310→Yes), the process proceeds to the next step S311.

In step S311 of FIG. 8, the scaling control unit 14 sets (initializes) the number of virtual resources (TotalNum) required as a whole to “0.”

Next, the scaling control unit 14 repeats the following processes for all hardware types (steps S312 to S314).

Specifically, in step S313, the scaling control unit 14 calculates TotalNum+(load total value/target value) for a certain type of hardware 3 selected. The calculated value is set as new TotalNum.

Here, in a case where there are a plurality of pieces of hardware 3 of one type, the total value of the loads is the total value of a plurality of loads. In addition, the target value is 90% for the HW_A and 60% for the HW_B of the requested resource set for each virtual resource in the resource config file.

By repeating this process of step S313 for all hardware types, TotalNum based on all hardware types is calculated.

Next, in step S315, the scaling control unit 14 calculates the number of virtual resources to be added/deleted (scale).

Specifically, the scaling control unit 14 rounds up the calculated TotalNum to an integer value (Ceil(TotalNum)) and subtracts the current number of virtual resources.

The scaling control unit 14 then determines whether the calculated number of virtual resources to be added/deleted (scale) is equal to or greater than 0 (step S316). When the calculated number of virtual resources to be added/deleted (scale) is equal to or greater than 0 (step S316→Yes), the process proceeds to step S317.

In step S317, the scaling control unit 14 transmits a request to add scale virtual resources (such as containers) to the virtualization platform 20. Meanwhile, when scale is 0, the request is not transmitted.

On the other hand, in step S316, the calculated number of virtual resources to be added/deleted (scale) is less than 0 (step S316→No), the process proceeds to step S318.

In step S318, the scaling control unit 14 transmits a request to delete scale virtual resources to the virtualization platform 20.

In this way, the scaling management device 10 can perform scaling in consideration of the electric power efficiency of each piece of hardware 3.

### <<Startup and Stop Processing of Hardware>>

FIG. 9 is a flowchart illustrating a flow of startup and stop processing of the hardware 3 according to the present embodiment.

Meanwhile, it is assumed that when the HW control unit 15 of the scaling management device 10 executes startup and stop processing of the hardware 3, the monitoring unit 13 acquires information on metrics (for example, CPU usage rate, resource usage rate based on RPS or the like) to be monitored for each piece of hardware 3.

When a container addition request is transmitted to the virtualization platform 20 through the processing of the scaling control unit 14, the HW control unit 15 receives a container addition failure response due to resource shortage from the virtualization platform 20 (step S401). In this case, the HW control unit 15 proceeds to step S406 in order to add new hardware 3.

In addition, for each piece of hardware 3, the HW control unit 15, for example, A % as an upper limit threshold (predetermined upper limit usage rate (predetermined first threshold)) and, for example, B % as a lower limit threshold (predetermined lower limit usage rate (predetermined second threshold)) of monitored metrics (resource usage rate such as CPU usage rate) (step S402).

Next, the HW control unit 15 calculates a moving average of metrics (resource usage rate) at predetermined intervals for each piece of hardware 3 (step S403).

Next, the HW control unit 15 determines whether a predetermined monitoring interval has been exceeded (step S404). When the predetermined monitoring interval is not exceeded (step S404→No), the process returns to step S403 and continues. On the other hand, when the predetermined monitoring interval is exceeded (step S403→Yes), the process proceeds to the next step S405.

Next, the HW control unit 15 determines whether the moving average of the calculated metrics (resource usage rate) is equal to or greater than a predetermined upper limit usage rate (A) (step S405). When it is equal to or greater than the predetermined upper limit usage rate (A) (step S405→Yes), the process proceeds to step S406.

In step S406, the HW control unit 15 selects hardware 3 to be added.

At that time, in order to minimize power consumption, the HW control unit 15 may select hardware 3 with low maximum power consumption or hardware 3 with low standby power, or may select hardware 3 with high (or low) maximum power consumption but high (or low) processing performance in accordance with the increasing traffic trend.

The HW control unit 15 then instructs the virtualization platform 20 to add the selected hardware 3 (step S407).

Specifically, the HW control unit 15 requests the virtualization platform 20 to start up the selected hardware 3, to thereby start up the hardware 3 and cause the resource management unit 21 of the virtualization platform 20 to add a free resource.

On the other hand, in step S405, in a case where the moving average of the calculated metrics (resource usage rate) is not equal to or greater than the predetermined upper limit usage rate (A) (step S405→No), the HW control unit 15 determines whether the moving average of the calculated metrics is less than the predetermined lower limit usage rate (B) (step 3408). When it is not less than the predetermined lower limit usage rate (B) (step S408→No), the process returns to step S403 and continues. On the other hand, when it is less than the predetermined lower limit usage rate (B) (step S408→Yes), the process proceeds to the next step 3409.

In step S409, the HW control unit 15 selects the hardware 3 to be stopped.

At that time, in order to minimize power consumption, the HW control unit 15 may select hardware 3 with high maximum power consumption or hardware 3 with high standby power, or may select hardware 3 with high (or low) maximum power consumption but high (or low) processing performance in accordance with the decreasing traffic trend.

Next, in step S410, when the hardware 3 to be stopped is selected, the HW control unit 15 instructs the virtualization platform 20 to stop distributing a request to the selected hardware 3. After the selected hardware 3 completes a request in process, the resource management unit 21 of the virtualization platform 20 stops the hardware 3.

In this way, the scaling management device 10 can perform hardware startup/stop processing in consideration of electric power efficiency.

### <Hardware Configuration>

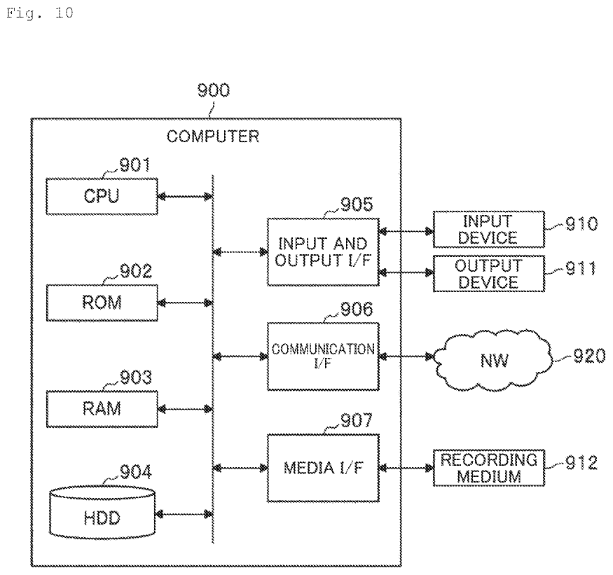

The scaling management device 10 according to the present embodiment is realized by a computer 900, for example, configured as shown in FIG. 10.

FIG. 10 is a hardware configuration diagram illustrating an example of the computer 900 that realizes the functions of the scaling management device 10 according to the present embodiment. The computer 900 includes a central processing unit (CPU) 901, a read only memory (ROM) 902, a RAM 903, a hard disk drive (HDD) 904, an input and output interface (I/F) 905, a communication I/F 906, and a media I/F 907.

The CPU 901 operates on the basis of a program stored in the ROM 902 or the HDD 904 and causes the control unit to perform control. The ROM 902 stores a boot program executed by the CPU 901 when the computer 900 is started up, a program related to the hardware of the computer 900, and the like.

The CPU 901 controls an input device 910 such as a mouse and a keyboard, and an output device 911 such as a display and a printer through the input and output I/F 905. The CPU 901 acquires data from the input device 910 through the input and output I/F 905 and outputs the generated data to the output device 911. Meanwhile, a graphics processing unit (GPU) or the like may be used as a processor together with the CPU 901.

The HDD 904 stores a program executed by the CPU 901, data used by the program, and the like. The communication I/F 906 receives data from other devices through a communication network (for example, a network (NW) 920), outputs it to the CPU 901, and transmits data generated by the CPU 901 to other devices through the communication network.

The media I/F 907 reads a program or data stored in a recording medium 912 and outputs them to the CPU 901 through the RAM 903. The CPU 901 loads a program related to desired processing from the recording medium 912 onto the RAM 903 through the media I/F 907, and executes the loaded program. The recording medium 912 is an optical recording medium such as a digital versatile disc (DVD) or a phase change rewritable disk (PD), a magneto optical recording medium such as a magneto optical disk (MO), a magnetic recording medium, a semiconductor memory, or the like.

For example, in a case where the computer 900 functions as the scaling management device 10 of the present invention, the CPU 901 of the computer 900 realizes the functions of the scaling management device 10 by executing a program loaded on the RAM 903. In addition, data in the RAM 903 is stored in the HDD 904. The CPU 901 reads a program related to desired processing from the recording medium 912 and executes it. In addition, the CPU 901 may read a program related to desired processing from other devices through the communication network (NW 920).

### <Effect>

Hereinafter, effects of the scaling management device 10 and the like according to the present invention will be described. A scaling management device according to the present invention is a scaling management device 10 configured to manage scaling of virtual resources mounted on hardware 3 through a virtualization platform 20. The scaling management device 10 includes: an electric power efficiency characteristic calculation unit 111 configured to calculate electric power efficiency characteristics of each of a plurality of pieces of the hardware 3 by measuring electric power efficiency of the hardware 3 while varying a level of a usage rate of the hardware 3, and determine a usage rate at which a value of electric power efficiency is highest among the measured electric power efficiencies; a performance ratio calculation unit 112 configured to measure performance of each piece of hardware 3 by measuring a predetermined metric, identify the hardware 3 having a lowest performance value, and calculate a performance value of other hardware 3 as a performance ratio in a case where a performance value of the identified hardware 3 is set to “1”; a virtual resource number calculation unit 121 configured to calculate a score obtained by multiplying the calculated performance ratio by the usage rate at which the value of electric power efficiency is highest for each piece of hardware 3, and calculate the number of virtual resources to be mounted on the hardware 3 in accordance with a ratio of magnitude of the score calculated for each piece of hardware 3; a requested resource calculation unit 122 configured to calculate requested resources for virtual resources to be mounted on the hardware 3 the performance value of which is lowest and the other hardware 3 by setting the requested resource of the hardware 3 having a lowest performance value to a value indicated by the performance ratio to “1” in a case where the requested resource for the virtual resource to be mounted on the other hardware 3 is set to “1” on the basis of the performance ratio of the other hardware 3 to the performance value “1” of the hardware 3 having a lowest performance value; and a config file creation unit 123 configured to create a scaling config file for each piece of hardware 3 with the usage rate at which the value of electric power efficiency is highest as a target value of scaling of the hardware 3, and create a resource config file including the calculated number of virtual resources to be mounted on the hardware 3 and the requested resources of the virtual resources to be mounted on the hardware 3.

According to this scaling management device 10, it is possible to perform scaling in consideration of performance differences and electric power efficiency characteristic differences of the hardware 3 in the virtualization platform 20. This makes it possible for each piece of hardware 3 to operate with a load amount having the highest electric power efficiency. In addition, the scaling management device 10 creates a resource config file in accordance with the performance difference of each piece of hardware 3, sets a target value of scaling according to the electric power efficiency characteristic difference, and creates a scaling config file. Therefore, in the virtualization platform 20, traffic need only be equally distributed to each virtual resource without considering the performance difference and electric power efficiency characteristic difference between the hardware 3. In addition, the scaling management device 10 further includes a monitoring unit 13 configured to acquire a usage rate of the virtual resources mounted on the hardware 3 in units of the hardware 3; and a scaling control unit 14 configured to determine addition or deletion of the virtual resources by comparing the acquired usage rate of the virtual resources with a target value of scaling indicated by the scaling config file.

In this way, the scaling management device 10 can determine addition/deletion of the virtual resources on the basis of the target value of scaling according to the electric power efficiency characteristic difference. Thus, it is possible to operate the virtualization platform 20 with reduced power consumption compared to the related art.

In addition, the scaling management device 10 further includes a hardware control unit 15 configured to determine hardware with low maximum power consumption or hardware with low standby power as hardware to be added in a case where the addition of the virtual resources falls or a case where the acquired usage rate of the virtual resources is higher than a predetermined first threshold.

In this way, the scaling management device 10 can select the hardware 3 having low maximum power consumption or low standby power when the hardware 3 is added. Thus, it is possible to reduce power consumption more than in the related art.

In addition, the scaling management device 10 further includes a hardware control unit 15 configured to determine the hardware 3 with high maximum electric power or the hardware 3 with high standby power as hardware to be stopped in a case where the acquired usage rate of the virtual resources is lower than a predetermined second threshold.

In this way, the scaling management device 10 can select the hardware 3 with high maximum power consumption or high standby power when the hardware 3 is stopped. Thus, power consumption can be reduced more than in the related art.

Meanwhile, the present invention is not limited to the embodiments described above, and various modifications can be made by a person of ordinary skill in the art within the technical idea of the present invention.

### REFERENCE SIGNS LIST

1 Scaling management system
3 Hardware (HW)
10 Scaling management device
11 HW characteristic calculation unit
12 Resource configuration unit
13 Monitoring unit
14 Scaling control unit
15 HW control unit (hardware control unit)
20 Virtualization platform
21 Resource management unit
22 Virtual resource control unit
111 Electric power efficiency characteristic calculation unit
112 Performance ratio calculation unit
121 Virtual resource number calculation unit
122 Requested resource calculation unit
123 Config file creation unit

1. A scaling management device configured to manage scaling of virtual resources mounted on hardware through a virtualization platform, the scaling management device comprising one or more processors configured to perform operations comprising:
calculating electric power efficiency characteristics of each of a plurality of pieces of the hardware by measuring electric power efficiency of the hardware while varying a level of a usage rate of the hardware, and determining a usage rate at which a value of electric power efficiency is highest among the measured electric power efficiencies;
measuring performance of each piece of hardware by measuring a predetermined metric, identifying the hardware having a lowest performance value, and calculating a performance value of other hardware as a performance ratio in a case where a performance value of the identified hardware is set to 1;
calculating a score obtained by multiplying the calculated performance ratio by the usage rate at which the value of electric power efficiency is highest for each piece of hardware, and calculating the number of virtual resources to be mounted on the hardware in accordance with a ratio of magnitude of the score calculated for each piece of hardware;
calculating requested resources for the virtual resources to be mounted on the hardware having a lowest performance value and the other hardware by setting the requested resource of the hardware having a lowest performance value to a value indicated by the performance ratio to 1 in a case where the requested resource for the virtual resource to be mounted on the other hardware is set to 1 on the basis of the performance ratio of the other hardware to the performance value 1 of the hardware having a lowest performance value; and
creating a scaling config file for each piece of hardware with the usage rate at which the value of electric power efficiency is highest as a target value of scaling of the hardware, and creating a resource config file including the calculated number of virtual resources to be mounted on the hardware and the requested resources of the virtual resources to be mounted on the hardware.

2. The scaling management device according to claim 1, h operations further comprising:
acquiring a usage rate of the virtual resources mounted on the hardware in units of the hardware; and
determining addition or deletion of the virtual resources by comparing the acquired usage rate of the virtual resources with a target value of scaling indicated by the scaling config file.

3. The scaling management device according to claim 2, the operations further comprising determining hardware with low maximum power consumption or hardware with low standby power as hardware to be added in a case where the addition of the virtual resources falls or a case where the acquired usage rate of the virtual resources is higher than a predetermined first threshold.

4. The scaling management device according to claim 2, h operations further comprising determining the hardware with high maximum electric power or the hardware with high standby power as hardware to be stopped in a case where the acquired usage rate of the virtual resources is lower than a predetermined second threshold.

5. A scaling management method for a scaling management device that manages scaling of virtual resources mounted on hardware through a virtualization platform, the scaling management method comprising:
calculating electric power efficiency characteristics of each of a plurality of pieces of the hardware by measuring electric power efficiency of the hardware while varying a level of a usage rate of the hardware, and determining a usage rate at which a value of electric power efficiency is highest among the measured electric power efficiencies;
measuring performance of each piece of hardware by measuring a predetermined metric, identifying the hardware having a lowest performance value, and calculating a performance value of other hardware as a performance ratio in a case where a performance value of the identified hardware is set to 1;
calculating a score obtained by multiplying the calculated performance ratio by the usage rate at which the value of electric power efficiency is highest for each piece of hardware, and calculating the number of virtual resources to be mounted on the hardware in accordance with a ratio of magnitude of the score calculated for each piece of hardware;
calculating requested resources for the virtual resources to be mounted on the hardware having a lowest performance value and the other hardware by setting the requested resource of the hardware having a lowest performance value to a value indicated by the performance ratio to 1 in a case where the requested resource for the virtual resource to be mounted on the other hardware is set to 1 on the basis of the performance ratio of the other hardware to the performance value 1 of the hardware having a lowest performance value; and
creating a scaling config file for each piece of hardware with the usage rate at which the value of electric power efficiency is highest as a target value of scaling of the hardware, and creating a resource config file including the calculated number of virtual resources to be mounted on the hardware and the requested resources of the virtual resources to be mounted on the hardware.

6. (canceled)

7. A non-transitory computer-readable medium storing program instructions that, when executed, cause one or more processors to perform operations comprising:
calculating electric power efficiency characteristics of each of a plurality of pieces of hardware by measuring electric power efficiency of the hardware while varying a level of a usage rate of the hardware, and determining a usage rate at which a value of electric power efficiency is highest among the measured electric power efficiencies;
measuring performance of each piece of hardware by measuring a predetermined metric, identifying the hardware having a lowest performance value, and calculating a performance value of other hardware as a performance ratio in a case where a performance value of the identified hardware is set to 1;
calculating a score obtained by multiplying the calculated performance ratio by the usage rate at which the value of electric power efficiency is highest for each piece of hardware, and calculating a number of virtual resources to be mounted on the hardware in accordance with a ratio of magnitude of the score calculated for each piece of hardware;
calculating requested resources for the virtual resources to be mounted on the hardware having a lowest performance value and the other hardware by setting the requested resource of the hardware having a lowest performance value to a value indicated by the performance ratio to 1 in a case where the requested resource for the virtual resource to be mounted on the other hardware is set to 1 on the basis of the performance ratio of the other hardware to the performance value 1 of the hardware having a lowest performance value; and
creating a scaling config file for each piece of hardware with the usage rate at which the value of electric power efficiency is highest as a target value of scaling of the hardware, and creating a resource config file including the calculated number of virtual resources to be mounted on the hardware and the requested resources of the virtual resources to be mounted on the hardware.
